(19) United States
(12) Patent Application Publication
(10) Pub. No.: US 2023/0418934 A1
(43) Pub. Date: Dec. 28, 2023

(54) CONTROL FLOW INTEGRITY TO PREVENT POTENTIAL LEAKAGE OF SENSITIVE DATA TO ADVERSARIES

(71) Applicant: Intel Corporation, Santa Clara, CA (US)

(72) Inventors: Scott D. Constable, Portland, OR (US); Joao Batista Correa Gomes Moreira, Hillsboro, OR (US); Alyssa A. Milburn, Den Haag (NL); Ke Sun, Portland, OR (US); Michael LeMay, Hillsboro, OR (US); David M. Durham, Beaverton, OR (US); Joseph Nuzman, Haifa (IL); Jason W. Brandt, Austin, TX (US); Anders Fogh, Luenen (DE)

(73) Assignee: Intel Corporation, Santa Clara, CA (US)

(21) Appl. No.: 17/849,351

(22) Filed: Jun. 24, 2022

(51) Int. Cl. G06F 21/54; G06F 21/51

(52) U.S. Cl. CPC G06F 21/54; G06F 21/51; G06F 2221/033

(57) ABSTRACT

In one embodiment, an indirect branch is detected in computer program code. The indirect branch calls one of a plurality of functions using a first register. In response, the computer program code is augmented to store an identifier of the indirect branch call in a second register, and the code for each of the plurality of functions is augmented to: determine whether an identifier for the function matches the identifier stored in the second register and render the first register unusable if the identifier for the function does not match the identifier stored in the second register.

### FIELD

This disclosure relates in general to the field of computer systems, and more particularly, to branch prediction control flow integrity to prevent the potential leakage of sensitive data to adversaries.

### BACKGROUND

Modern out-of-order processors may use branch prediction to improve performance. However, branch prediction can also be trained by a malicious adversary to steer the instruction pointer to an adversary-desired location, potentially resulting in the leakage of sensitive data. These attacks are commonly known as Spectre v2 or Branch Target Injection (BTI).

### BRIEF DESCRIPTION OF THE DRAWINGS

To provide a more complete understanding of the present disclosure and features and advantages thereof, reference is made to the following description, taken in conjunction with the accompanying figures, where like reference numerals represent like parts.

FIG. 1 is a diagram of a program with function pointer and a memory storing multiple functions that can potentially be called by the function pointer under current hardening techniques.

FIG. 2 is a listing of compiled instructions for the program and certain of the functions of FIG. 1 under current hardening techniques.

FIG. 3 is a listing of example compiled instructions for functions of FIG. 1 that are hardened according to embodiments of the present disclosure.

FIG. 4 is a listing of other example hardening instructions that can be used in embodiments of the present disclosure.

FIGS. 5A-5B are listings of further example hardening instructions that can be used in embodiments of the present disclosure.

FIG. 6 is a diagram of the program of FIG. 1 and a memory storing multiple functions that are hardened according to embodiments of the present disclosure.

FIG. 7 is a listing of pseudocode for speculative load hardening, which may be used in embodiments of the present disclosure.

FIG. 8 is a flow diagram of an example process of hardening computer program code and function code against indirect branch target attacks according to embodiments of the present disclosure.

FIG. 9 is a code snippet of example instructions that utilize prefixes according to embodiments of the present disclosure.

FIG. 10 is a block diagram illustrating an example processor according to at least one embodiment.

FIG. 11A is a block diagram illustrating both an exemplary in-order pipeline and an exemplary register renaming, out-of-order issue/execution pipeline in accordance with certain embodiments.

FIG. 11B is a block diagram illustrating both an exemplary embodiment of an in-order architecture core and an exemplary register renaming, out-of-order issue/execution architecture core to be included in a processor in accordance with certain embodiments.

FIG. 12 is a block diagram of an example computer architecture according to at least one embodiment.

FIG. 13 is a block diagram contrasting the use of a software instruction converter to convert binary instructions in a source instruction set to binary instructions in a target instruction set according to embodiments of the present disclosure.

### DETAILED DESCRIPTION

This disclosure provides various embodiments that can mitigate intra-mode BTI (IMBTI) vulnerabilities without disabling indirect branch prediction, allowing for potentially improved performance for platforms or workloads that require IMBTI mitigation. Modern out-of-order processors use branch prediction to improve performance. However, branch prediction can also be abused by a malicious adversary to steer the instruction pointer to an adversary-desired location, potentially resulting in the leakage of sensitive data. Current techniques involve software- and hardware-based solutions, such as complete disabling of branch prediction via software (e.g., Retpoline) or hardware (e.g., some CPU vendors expose a “switch” to disable indirect branch predictions within a particular mode such as a superuser/kernel mode), hardware-based predictor modes that prevent injection of branch targets between modes (e.g., Intel® Enhanced Indirect Branch Restricted Speculation (eIBRS)), or associating pointers with metadata to constrain pointer usage (e.g., Capability Hardware Enhanced RISC Instructions (CHERI)). Other solutions involve architectural control-flow integrity (CFI)-based solutions, such as Intel® CET-IBT, which requires all indirect branches to land on an ENDBR (end branch) instruction, and can also prevent a CPU from speculatively executing code after an indirect branch prediction to an instruction that is not an ENDBR, or FineIBT, which builds on CET-IBT to ensure that a call site and callee types match each time an indirect call is made.

However, disabling indirect branch prediction with either a hardware switch or a software solution can cause a significant performance regression, such as, for example, approximately 20% on SPEC CPU. Further, CHERI is a heavyweight solution with many hardware and software touchpoints and can incur both memory and execution overhead. The eIBRS and CET-IBT can provide lighter weight solutions; however, they do not comprehensively mitigate BTI. FineIBT provides fine-grained architectural security guarantees, but these guarantees do not apply to speculative execution, and therefore do not mitigate BTI-style attacks, including IMBTI.

Embodiments of the present disclosure, on the other hand, may mitigate BTI-style attacks, including IMBTI. For instance, embodiments may include extensions of the FineIBT application binary interface (ABI) that provide fine-grained hardening against BTI attacks. The ABI can be implemented using existing architectural features (such as, for example, CET-IBT) coupled with software extensions. Other embodiments herein may include architectural hardware-based CFI solutions, e.g., through new instruction set architecture (ISA), to provide similar hardening against BTI-style attacks.

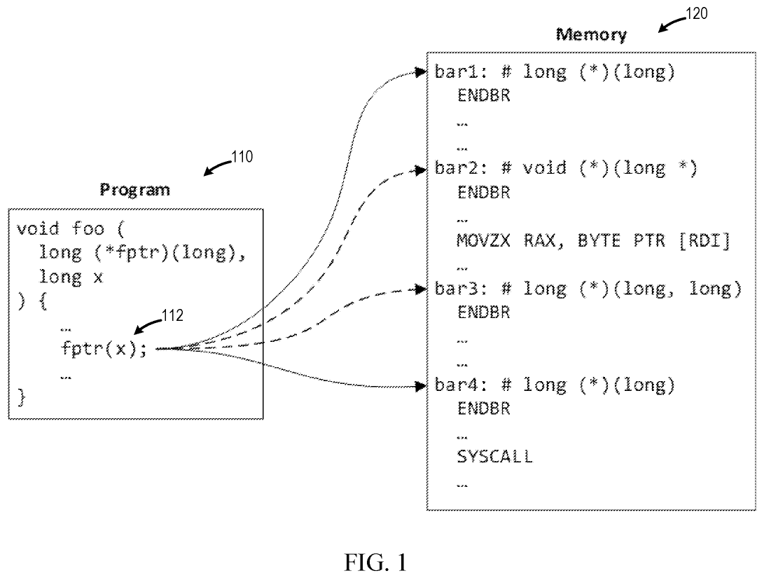

FIG. 1 is a diagram of a program 110 with function pointer 112 and a memory 120 storing multiple functions that can potentially be called by the function pointer 112 under current hardening techniques. In particular, the diagram of FIG. 1 shows valid execution paths under CET-IBT and FineIBT, with the solid arrows representing execution paths that are valid under FineIBT and CET-IBT and dashed arrows representing execution paths that are valid under CET-IBT, but not under FineIBT. CET-IBT enforces that each indirect call/jump must land on an ENDBR instruction, as described above, with a failure to land immediately on ENDBR triggering a control flow protection fault. As shown in FIG. 1, each of the functions bar1, bar2, bar3, and bar4 begin with an ENDBR instruction, and so they are valid under CET-IBT. When foo( ) in the program 110 issues an indirect call through the function pointer 112 (fptr( )), the instruction pointer (e.g., EIP/RIP) can only transfer to one of the four addresses in the memory where the functions bar1, bar2, bar3, and bar4 are stored. If the function pointer 112 refers to a non-ENDBR target (e.g., the SYSCALL in bar4), the processor will issue a fault and terminate the program.

CET-IBT can also restrict speculative execution in certain instances. For example, a branch predictor could mis-predict that the indirect call through the function pointer 112 will resolve to the MOVZX instruction in bar2. CET-IBT can prevent instructions from being executed speculatively following a branch mis-prediction if the predicted target does not begin with an ENDBR instruction. Hence the MOVZX instruction would not be allowed to execute speculatively under CET-IBT. However, if the call through the function pointer 112 mis-predicts to bar2 then the processor can execute instructions speculatively because bar2 begins with an ENDBR. In this example, bar2's type differs from the function pointer's type, and hence the integer argument passed in the RDI register would be treated (speculatively) as a pointer, possibly to load an adversary-desired secret from memory. This style of attack is called intra-mode BTI (IMBTI), which cannot be prevented by CET-IBT alone.

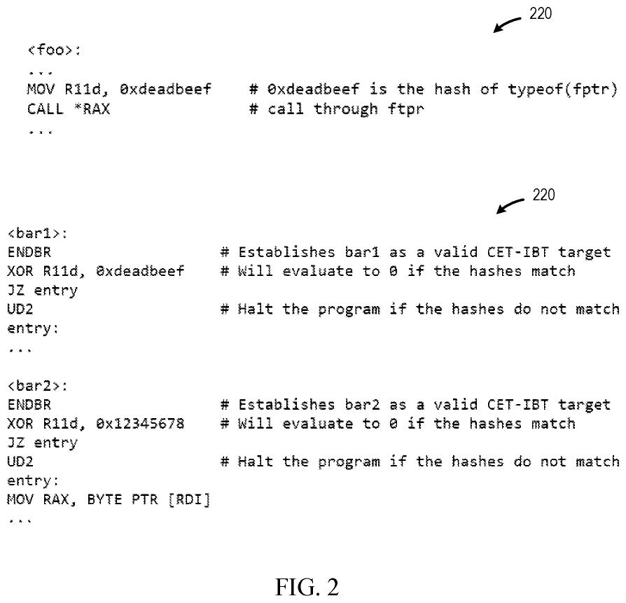

FIG. 2 is a listing of compiled instructions for the program and certain of the functions of FIG. 1 under current hardening techniques, specifically, under FineIBT. FineIBT is an ABI that builds on CET-IBT to enforce type-based safety. For instance, under FineIBT, the function pointer 112 call in foo( ) would be preceded by an instruction, which may be inserted by the compiler, that moves a hash of a type of the function pointer 112 (0xdeadbeef in the example shown) into register R11, as shown in the code snippet 210. Additionally, instructions may be inserted into the compiled functions in memory to check for a match in the function type, as shown in code snippet 220. In the example shown, for instance, an XOR operation is used to determine whether the hash of the barX function matches the hash value stored in the R11 register, and if a match is not detected, then a UD2 operation halts the program execution. If a match is detected, however, the jump zero (JZ) operation is used to bypass the UD2 halt operation to go directly to the program entry (as indicated by “entry:” in FIG. 2). Thus, if the function pointer 112 is used to call bar1 the program will proceed, but if the function pointer 112 is used to call bar2 the program will halt. Accordingly, this mechanism enforces that the function pointer invoking the call and the target callee must have the same function type (barring the remote probability of a hash collision). Different implementations of FineIBT may use different instructions to set and check the hash, for example, SUB instead of XOR. In addition, other types of identifiers can be used for the function instead of the function type. For example, any suitable identifier can be chosen such that it identifies a group or class of branch targets, and any identifier of a target code characteristic can be used. The group/class identifier may be chosen such that a branch can only go to members of the group/class. In some embodiments, the identifier can be manually coded or labeled into functions. In other embodiments, such as those described herein, the function type or another inherent function characteristic can be used. For instance, in certain embodiments, a function arity (i.e., the number of function parameters) may be used to identify a class of branch targets.

One limitation of FineIBT, however, is that its mechanism can only be enforced architecturally, and thus, it does not necessarily hold for speculative execution. In particular, the Jcc (in this example, JZ) is a conditional branch that could be mis-predicted (e.g., maliciously) by the processor's branch prediction unit. For example, if the function pointer is used to call bar2 then the branch prediction unit could predict that the JZ will be taken, in which case instructions in bar2 could execute speculatively and leak data. Thus, FineIBT will not mitigate microarchitectural BTI-style attacks like IMBTI.

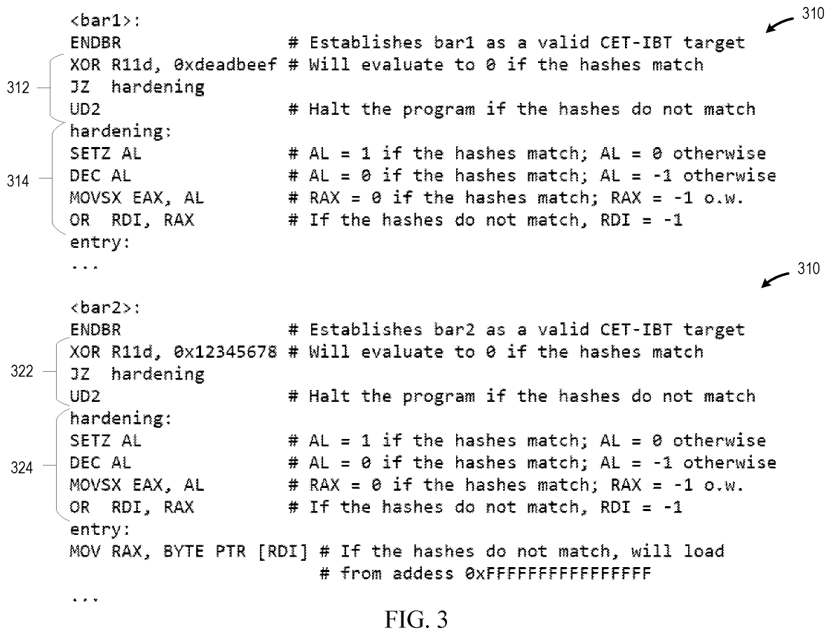

FIG. 3 is a listing of example compiled instructions for functions of FIG. 1 that are hardened according to embodiments of the present disclosure. In particular, FIG. 3 illustrates example instructions 312, 314, 322, 324 that may be inserted into the compiled bar1 instructions 310 and bar2 instructions 320 to harden against BTI-style attacks. The instructions 312, 314, 322, 324 may be inserted by any suitable tool, such as, for example, a compiler at the time of code generation or when code is emitted, or by a linker that links object files generated by a compiler and combines them into an executable program, or by a live patching framework, or by a binary rewriting tool. The instructions 312, 322 are similar to those described above with respect to FIG. 2. That is, the instructions 312, 322 provide a check for a function type match before allowing further execution. However, in other embodiments, other types of identifiers may be used to check/verify in the instructions 312, 322 other than a function type, as described above. If the function type matches in the XOR operation, then the JZ operation jumps the UD2 (halt) operation (which only executes if there is not a type match in the XOR operation, as above) to the hardening instructions 314, 324. The hardening instructions 314, 324 may execute, upon a match in the XOR operation of the instructions 312, 322, before the main function instructions (indicated by the “entry:”). The hardening instructions 314, 324 may effectively render certain registers as unusable if there is not a match in the function type (and/or other identifier used).

For instance, referring to the example shown in FIG. 3, suppose that that the processor's branch predictor predicts bar1 as the target for the indirect call through the function pointer 112. Since the type hashes match (i.e., 0xdeadbeef in the example shown), the XOR operation in the instructions 312 will set a zero flag (ZF) and the JZ will branch to the hardening procedure (indicated by “hardening:”, i.e., the hardening instructions 314, 324). Because ZF is set, SETZ will set the lowest bit in an AL register, and the subsequent instructions will, decrement AL to 0, sign-extend 0 into the RAX register, logical-OR 0 and the RDI register value, and write the result into the RDI register, thus leaving the RDI register value unchanged. Thus, when the hashes match, the hardening procedure effectively does nothing, and execution is allowed to proceed to the function body as normal.

However, suppose that that the processor's branch predictor predicts bar2 as the target. Now the XOR operation in the instructions 322 will not set the zero flag (ZF) and the JZ will branch to the hardening procedure (unless the JZ is also mis-predicted as taken). In this case the hardening procedure will set the AL register to 0 and then decrement AL to −1, sign-extend −1 into the RAX register (i.e., RAX will contain 0xFFFFFFFFFFFFFFFF), logical-OR −1 and the RDI register value, and write the result into the RDI register, setting RDI to −1. Thus, when the hashes do not match, the hardening procedure writes a fixed value into the live register containing the function's lone argument, RDI. Accordingly, the instructions 314, 324 can prevent a malicious adversary from using speculatively executed instructions that depend on RDI to load and leak sensitive data through a covert channel.

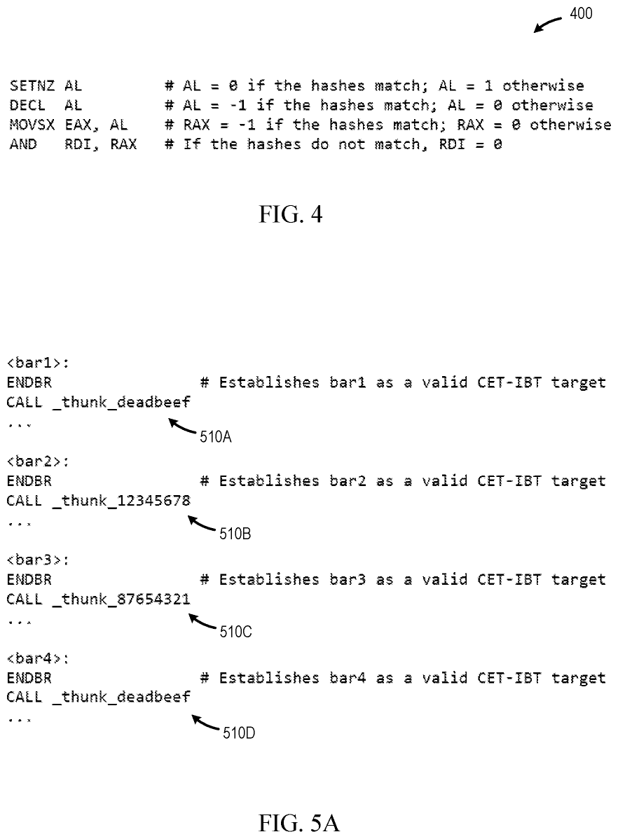

Although particular instructions are shown to render the register value of RDI unusable in the event of a type mismatch, embodiments may utilize other techniques to accomplish the same. For instance, rather than checking for a match in the function type, embodiments may check for a match in another type of identifier of a function class/group. As another example, the instructions may be repeated for other register arguments (i.e., used for multiple registers to render them unusable in the event of an identifier mismatch). As yet another example, a different fixed value may be used to render the register unusable instead of 0xFFFFFFFFFFFFFFFF as shown in FIG. 3. Further, other instructions sequences may be used, e.g., those shown in FIG. 4.

FIG. 4 is a listing of other example hardening instructions 400 that can be used in embodiments of the present disclosure. The example instructions shown in FIG. 4 mask the register value by using a logical-AND instead of logical-OR as in FIG. 3. This alternative implementation could be more useful in the kernel, where address 0 is not typically a valid kernel address. The example instructions 400 include a SETNZ operation that sets the AL registers value to 0 if the XOR operation in the instructions 312, 322 indicate a match in the function identifier or 1 if there is no match. The instructions then decrement the AL register value, sign-extend the AL register value into the RAX register, logical-AND the RAX and the RDI register values, and then write the result into the RDI register. As above, this will leave the RDI register value effectively unchanged where the function identifier (e.g., type) matches, but will render the RDI register value unusable otherwise.

It will be seen that the security provided by the hardening instructions herein does not depend on whether the indirect branch or the conditional branch (the JZ) is predicted correctly or incorrectly. For instance, there are four possible cases: (1) the indirect branch predicts correctly, and the conditional branch predicts correctly; (2) indirect branch predicts incorrectly, and the conditional branch predicts correctly; (3) indirect branch predicts correctly, and the conditional branch predicts incorrectly; and (4) the indirect branch predicts incorrectly, and the conditional branch predicts incorrectly. In the first case, none of the parameter registers are masked/hardened and the callee semantics is unaffected since prediction is correct in both instances. In the second case, if the indirect branch predicts to a target with a type that differs from that of the function pointer, then the hash check will set ZF and the hardening procedure will mask/harden all parameter registers. Execution may proceed speculatively with the hardened values, but the adversary will not be able to control them. If the indirect branch predicts to the wrong target but the types do match, then execution may proceed with unhardened values. In most circumstances this is not useful to the adversary because BTI/IMBTI attacks typically involve an adversary-controlled integer value being interpreted speculatively as a pointer. In the third case, the hashes must match, but the processor may speculatively execute the UD2. Most processors do not speculatively execute instructions after encountering a trap such as UD2, and even if the processor does execute subsequent instructions, these instructions comprise the hardening procedure, whose semantics depends on the value in ZF and not the outcome of the conditional branch. Finally, in the fourth case, the hashes do not match and the JZ is predicted as taken, in which case the hardening is applied to all parameter registers.

In certain instances, rather than inserting the hardening instructions into each function as indicated in FIG. 3, the hardening instructions may be implemented as a code segment that is shared by all functions of the same arity (i.e., functions that have the same number of parameters). In addition, in some embodiments, the function identifier comparison (e.g., the instructions 312, 322 above) can be implemented in the same or separate code segment.

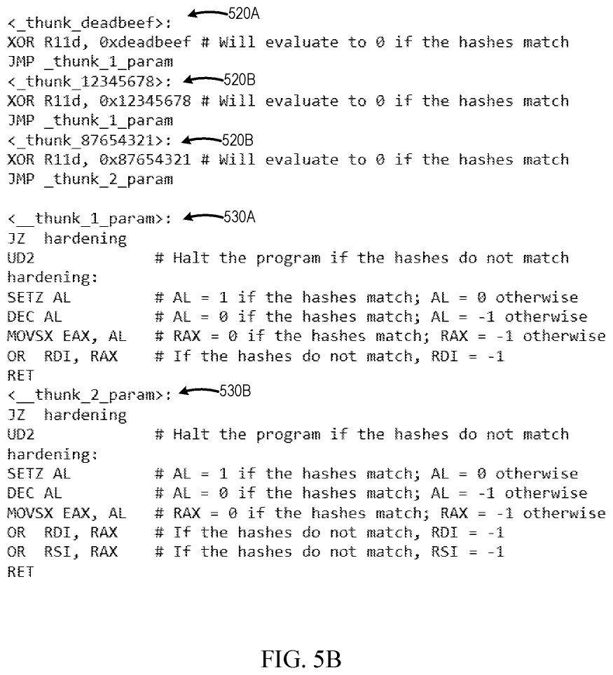

FIGS. 5A-5B are listings of example hardening instructions that can be used in embodiments of the present disclosure, e.g., where code segments are used. As shown in FIG. 5A, a call 510 to a function identifier code segment (e.g., segments 520 of FIG. 5B) that performs the function identifier check. The function identifier code segments 520 can then each call a hardening instruction code segment (e.g., segments 530 of FIG. 5B). In some embodiments, e.g., as shown in FIGS. 5A-5B, each unique function of the same type can utilize the same call. For instance, the indirect call targets bar1 and bar4 have the same function type and therefore can share the same hash comparison in the _thunk_deadbeef segment 520A of FIG. 5B. Likewise, functions of the same arity can share the same hardening code segment. For instance, targets bar1, bar2, and bar4 all have an arity of 1, and therefore can share the same _thunk_1_param hardening code segment 530A of FIG. 5B. Target bar4 has an arity of 2 and must use a different hardening code in the _thunk_2_param hardening code segment 530B of FIG. 5B.

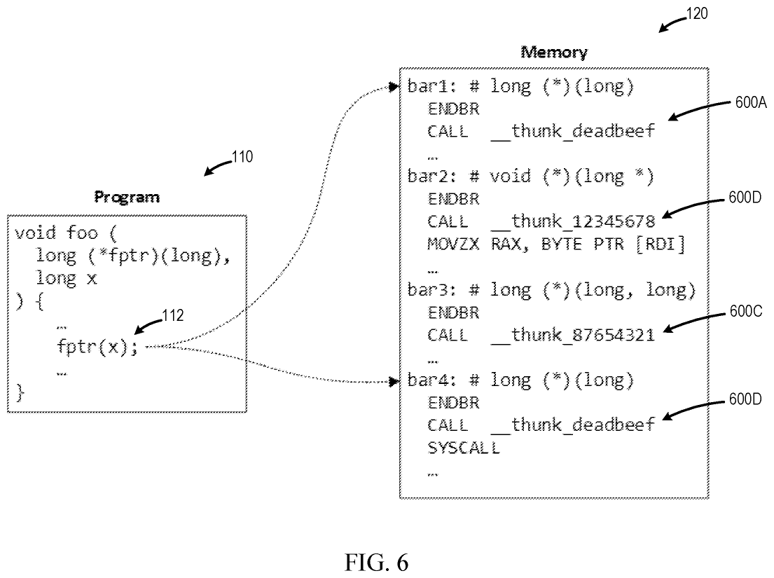

FIG. 6 is a diagram of the program 110 and memory 120 of FIG. 1, with the memory storing multiple functions that are hardened with code segments 600 according to embodiments of the present disclosure. In particular, FIG. 6 shows the allowable control flow for the function pointer 112 using the code segments shown in FIGS. 5A-5B. The dotted arrows represent execution paths (including speculative ones) that are valid over the ABI defined above. The execution paths shown are valid because (1) they begin with the ENDBR instruction, (2) have a function type hash value of 0xdeadbeef that matches the function pointer 112, and (3) utilize hardening instructions as described herein, e.g., those shown in FIG. 5B.

Although a specific ABI is used in the above examples, aspects of the present disclosure can be modified to conform to various system ABIs, since each processor architecture (e.g., x86, ARM, RISC-V, etc.) supports its own system ABIs and calling conventions. For example, the System V ABI used by Linux employs RDI, RSI, RDX, RCX, R8, and R9 to pass call parameters 1-6, respectively. Further arguments are passed on the stack, thus, the stack pointer RSP may also be masked/hardened in certain embodiments. The Microsoft x64 calling convention passes parameters 1-4 in registers RCX, RDX, R8, and R9, respectively, with further arguments passed on the stack. Hence, a conforming implementation of _thunk_1_param described above for the Microsoft x64 calling convention may harden RCX instead of RDI.

Further, in some embodiments, a WAITcc instruction can be used that prevents speculative execution from proceeding past the instruction if the specified condition code is satisfied, or at least from changing microarchitectural state in ways that are detectable from other threads or after the misspeculation has been unwound. For example, a WAITNZ instruction could be used in place of the SETZ instruction described above and/or in the subsequent masking operations in each of the code sequences described above to provide hardening.

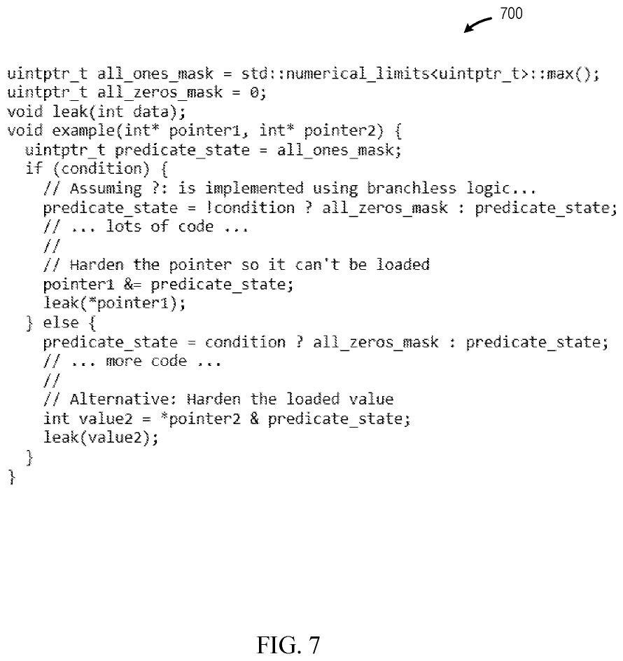

It will be understood that hardening of non-parameter registers is not needed because these are typically considered to be dead when a function is entered. Hence compilers will not generate code that uses these registers before they are defined within the function. It is possible for a register to be used speculatively before it is defined, but this would be a Spectre v1 vulnerability, and can be addressed by other techniques such as speculative load hardening (SLH), which is a compiler pass that uses a similar technique to mask data values to mitigate Spectre-BCB attacks (also known as Spectre-PHT or Spectre v1). SLH inserts instrumentation into each function to accumulate a predicate state that tracks whether any prior conditional branch has mis-speculated. This predicate state is used to mask/harden memory accesses within the function. FIG. 7 is a listing of pseudocode 700 for speculative load hardening, which may be used in embodiments of the present disclosure. The example pseudocode shown illustrates how SLH aggregates predicate state over each conditional branch in a C program and uses the predicate state to harden pointers so that they cannot be used to unintentionally load data if the direction of a conditional branch is mis-predicted by the processor.

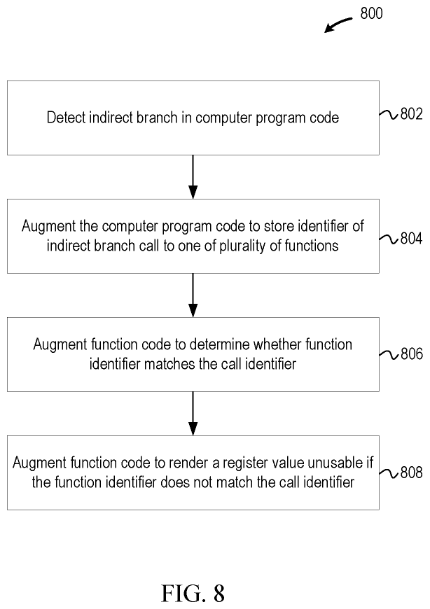

FIG. 8 is a flow diagram of an example process 800 of hardening computer program code and function code against indirect branch target attacks according to embodiments of the present disclosure. Aspects of the example process 800 may be performed by tooling such as a compiler or linker, or by live patching framework. The example process 800 may include additional or different operations, and the operations may be performed in the order shown or in another order. In some cases, one or more of the operations shown in FIG. 8 are implemented as processes that include multiple operations, sub-processes, or other types of routines. In some cases, operations can be combined, performed in another order, performed in parallel, iterated, or otherwise repeated or performed another manner.

At 802, the tooling (e.g., compiler, linker, live patching framework, or binary rewriting/transformation tool) detects an indirect branch in computer program code. The indirect branch may be a function pointer, for example. For instance, referring to the examples above, the tooling may identify the function pointer 112 of FIG. 1 as an indirect branch and proceed with the operations of FIG. 8 accordingly. The tooling may also identify one or more registers called by the function pointer. For instance, in the examples above, the RAX register may be identified as a register called by the function pointer. For instance, the tooling may be a translator between source code and machine code and may identify the indirect branch in the source code, and augment machine code that is output based on the source code according to the operations below. That is, the tooling may output machine code/instructions that are based on the source code, where the output machine code/instructions include a set of instructions corresponding just to the source code and additional inserted instructions that harden the code/instructions as described above.

At 804, the tooling augments the program code to store an identifier of the indirect branch call in a register. For example, the tooling may insert one or more instructions (e.g., machine code/instructions) that store an identifier of the function call in a register, such as an R11d register. The identifier may be, in some embodiments, a function type, or may be based on the function type, e.g., a hash of the function type. Referring to the example shown in FIG. 3, for instance, the tooling may insert/add the “MOV R11d, 0xdeadbeef” instruction, in which the hash of the function type “0xdeadbeef” is the identifier and is stored by the instruction in the R11d register, before the instruction that corresponds to the indirect branch, e.g., the “CALL*RAX” instruction shown in FIG. 3.

At 806, the tooling augments the code for one or more functions that could possibly be called by the indirect branch to determine whether the identifier for the function matches the identifier stored in the register associated with the indirect branch. The tooling may augment the function code by inserting instructions directly into the function code (e.g., as shown in FIG. 3) or may insert a call to one or more code snippets (e.g., as shown in FIGS. 5A-5B). The tooling may insert such an instruction (or call) prior to instructions of the function (e.g., those that implement the original source code). Referring again to the example shown in FIG. 3, the tooling may insert the “XOR R11d, 0xdeadbeef” instruction and/or the “XOR R11d, 0x12345678” instruction into the function code. Referring alternatively to the example shown in FIGS. 5A-5B, the “CALL_thunk_deadbeef” instruction or “CALL_thunk_12345678” instruction can be inserted into the function code, where such an instruction calls the corresponding code snippets that include a similar XOR operation.

At 808, the tooling augments the code for the one or more functions that could possibly be called by the indirect branch to render the called register unusable if the identifiers do not match at 806. The tooling may augment the function code by inserting instructions directly into the function code (e.g., as shown in FIG. 3) or may insert a call to one or more code snippets (e.g., as shown in FIGS. 5A-5B). The tooling may insert such instructions (or call(s)) prior to instructions of the function (e.g., those that implement the original source code). Referring again to the example shown in FIG. 3, the tooling may insert the hardening instructions 314, 324 into the function code. Referring alternatively to the example shown in FIGS. 5A-5B, the “CALL_thunk_deadbeef” instruction or “CALL_thunk_12345678” instruction can be inserted into the function code, where such an instruction calls the corresponding code snippets that include the hardening instructions.

While the above examples provide software-based techniques for hardening against BTI-style attacks, hardware-based techniques may be used as well. For instance, instruction set architecture (ISA) extensions may be used that implement the same or similar protections as described above. For example, some embodiments may provide an alternate encoding of the ENDBR instruction that would allow software to indicate (e.g., with an immediate bitvector) the set of registers that should be hardened. The processor could then delay execution of operations that use these registers until the branch resolves or retires. As another example, alternate encodings of the indirect CALL/JMP instructions and ENDBR instructions that allow software to specify a register/immediate ID can be used. The processor would then enforce that the ID at the call/jump target must match the ID at the call/jump site.

As yet another example, an alternate ENDBR encoding can be used that makes control-flow jumps a specific number of bytes whenever reached through a direct branch, allowing a sequence of hardening instructions between the ENDBR and the address targeted by the operand are only executed when reached indirectly. This number of bytes can either be fixed or defined by a new operand introduced by the new encoding. Alternatively, another NOP encoding can be used after the ENDBR instruction, which would implement the behavior described in a backwards-compatible manner (by avoiding changes to the ENDBR instruction itself).

In some embodiments, a CISC X86 instruction encoding could allow embedding restrictions on targetable ENDBR instructions within existing indirect branch types. For example, JMP and CALL instruction variants accepting a memory operand can be defined that accept 32-bit displacement values. In a new mode, the displacement could be interpreted as specifying an address slice of valid ENDBR target locations. If the relevant slice (e.g., bits 14:0 or some other configurable bit range) of the predicted destination address does not match the encoded displacement value, then speculation could be halted until the prediction has been verified. Other interpretations of the displacement value are possible, such as requiring that it match a hash of the linear address slice of the predicted branch target to permit that address slice to exceed the size of the displacement.

Other aspects of the encoding could be interpreted analogously, possibly in combination with new ENDBR variants. For example, the index of the register containing the indirect branch target could be matched against a 4-bit function type ID embedded as an immediate operand in an ENDBR variant. The size of the ID could be extended by incorporating additional info, e.g., the scale and the index register ID.

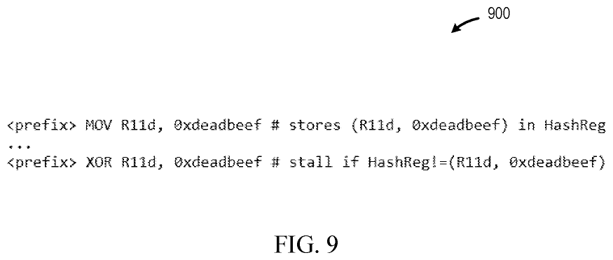

Some embodiments may employ a combination of software- and hardware-based techniques. For instance, prefixes may be added to the MOV and XOR (or SUB) instructions described above to allow software to indicate that they are being used to restrict speculative execution. As an example, after allocation of a MOV instruction with a specific prefix, the processor could store the associated constant (corresponding to the hash value) and other relevant information in an internal register (allowing for register renaming), and then the processor could stall at allocation of a XOR/SUB instruction with a specific prefix, unless the constant specified by the XOR/SUB instruction matches the constant in the internal register (and other relevant information, such as the register number), or the register contents are no longer speculative. The code snippet shown in FIG. 9 demonstrates how such a prefix would be interpreted by the processor. In the example shown, HashReg refers to the internal microarchitectural register described above that would store the associated constant.

As another example, a prefix could be added to a conditional branch (for example, the JZ operation described above) to allow the processor to restrict speculative execution until the conditional branch resolves. For example, the processor could track the contents of a specific register (such as R11d), and the processor could stall the conditional branch (or force a misprediction) until the value of the register is known to match.

As yet another example, a prefix could be added to the MOV instruction, together with an alternative ENDBR instruction that would allow a constant to be specified. The processor would enforce that the constant provided with the MOV instruction matches the constant encoded in the ENDBR. The constant may be similar to the constant described above, e.g., a constant that corresponds to the hash value.

Note that any of the prefix-based embodiments above could use an instruction prefix that is ignored by current architectures. For example, x86-64 no longer uses the ES segment override prefix, and hence this prefix is ignored under most circumstances. Prefix chaining is also an option for certain embodiments. For example, redundant REX prefixes are ignored by x86-64 instructions. Hence, two identical REX prefixes could be used to encode a new instruction prefix. An embodiment could use this prefix-based approach to achieve backward compatibility with legacy architectures. If backwards compatibility is not required, then each of the prefix-based embodiments above could instead be implemented as new instructions.

In some embodiments, code encryption can address invalid branches. For example, the displacement value in a branch with a memory operand could be interpreted as a new tweak to be used when fetching from the branch target. Alternatively, a new instruction could be defined that accepts a larger tweak or key as an immediate operand.

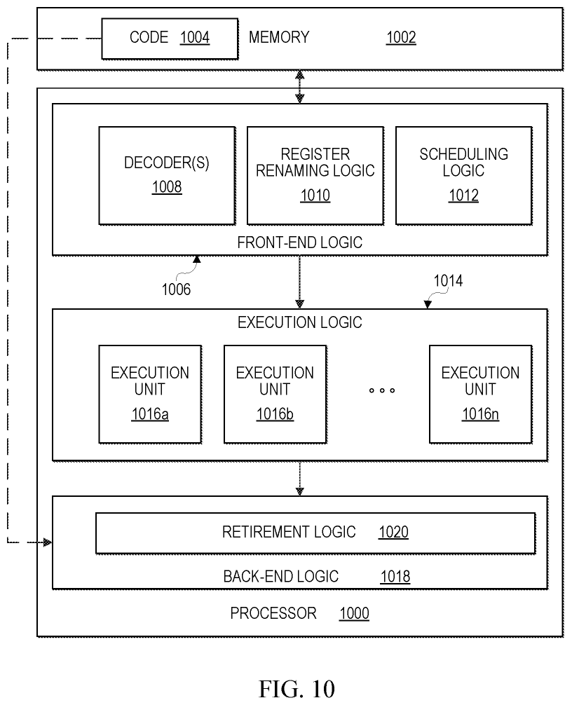

Generally, any computer architecture designs known in the art for processors and computing systems may be used. In an example, system designs and configurations known in the arts for laptops, desktops, handheld PCs, personal digital assistants, tablets, engineering workstations, servers, network devices, servers, appliances, network hubs, routers, switches, embedded processors, digital signal processors (DSPs), graphics devices, video game devices, set-top boxes, micro controllers, smart phones, mobile devices, wearable electronic devices, portable media players, hand held devices, and various other electronic devices, are also suitable for embodiments of computing systems described herein. FIGS. 10-13 below provide some example computing devices, architecture, hardware, software, or flows that may be used in the context of embodiments as described herein.

FIG. 10 is an example illustration of a processor according to an embodiment. Processor 1000 is an example of a type of hardware device that can be used in connection with the implementations shown and described herein. Processor 1000 may be any type of processor, such as a microprocessor, an embedded processor, a digital signal processor (DSP), a network processor, a multi-core processor, a single core processor, or other device to execute code. Although only one processor 1000 is illustrated in FIG. 10, a processing element may alternatively include more than one of processor 1000 illustrated in FIG. 10. Processor 1000 may be a single-threaded core or, for at least one embodiment, the processor 1000 may be multi-threaded in that it may include more than one hardware thread context (or “logical processor”) per core.

FIG. 10 also illustrates a memory 1002 coupled to processor 1000 in accordance with an embodiment. Memory 1002 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 1000 can execute any type of instructions associated with algorithms, processes, or operations detailed herein. Generally, processor 1000 can transform an element or an article (e.g., data) from one state or thing to another state or thing.

Code 1004, which may be one or more instructions to be executed by processor 1000, may be stored in memory 1002, or may be stored in software, hardware, firmware, or any suitable combination thereof, or in any other internal or external component, device, element, or object where appropriate and based on particular needs. In one example, processor 1000 can follow a program sequence of instructions indicated by code 1004. Each instruction enters a front-end logic 1006 and is processed by one or more decoders 1008. The decoder may generate, as its output, a micro operation such as a fixed width micro operation in a predefined format, or may generate other instructions, microinstructions, or control signals that reflect the original code instruction. Front-end logic 1006 also includes register renaming logic 1010 and scheduling logic 1012, which generally allocate resources and queue the operation corresponding to the instruction for execution.

Processor 1000 can also include execution logic 1014 having a set of execution units 1016a, 1016b, 1016n, etc. Some embodiments may include a number of execution units dedicated to specific functions or sets of functions. Other embodiments may include only one execution unit or one execution unit that can perform a particular function. Execution logic 1014 performs the operations specified by code instructions.

After completion of execution of the operations specified by the code instructions, back-end logic 1018 can retire the instructions of code 1004. In one embodiment, processor 1000 allows out of order execution but requires in order retirement of instructions. Retirement logic 1020 may take a variety of known forms (e.g., re-order buffers or the like). In this manner, processor 1000 is transformed during execution of code 1004, at least in terms of the output generated by the decoder, hardware registers and tables utilized by register renaming logic 1010, and any registers (not shown) modified by execution logic 1014.

Although not shown in FIG. 10, a processing element may include other elements on a chip with processor 1000. For example, a processing element may include memory control logic along with processor 1000. The processing element may include I/O control logic and/or may include I/O control logic integrated with memory control logic. The processing element may also include one or more caches. In some embodiments, non-volatile memory (such as flash memory or fuses) may also be included on the chip with processor 1000.

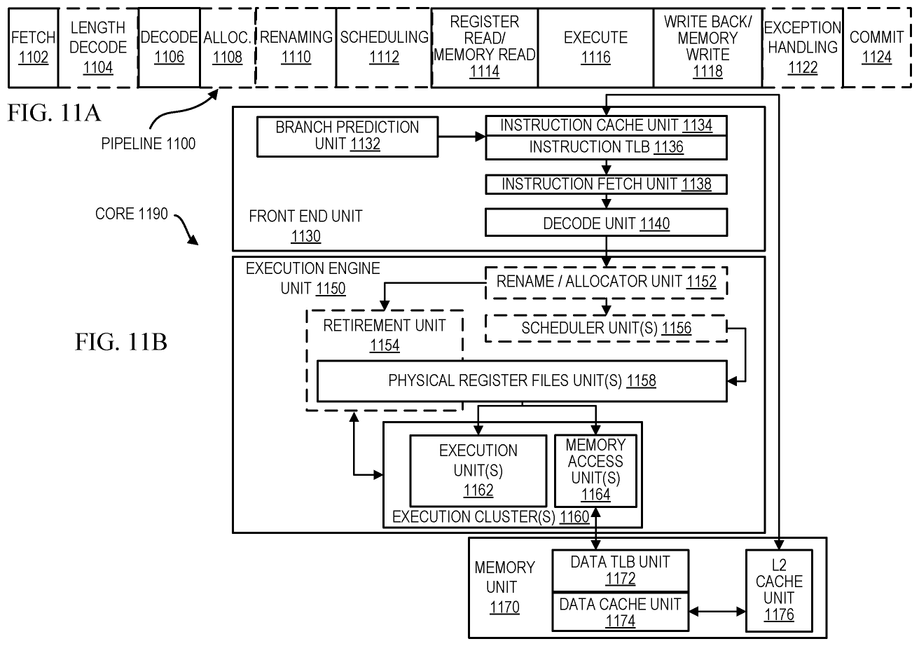

FIG. 11A is a block diagram illustrating both an exemplary in-order pipeline and an exemplary register renaming, out-of-order issue/execution pipeline according to one or more embodiments of this disclosure. FIG. 11B is a block diagram illustrating both an exemplary embodiment of an in-order architecture core and an exemplary register renaming, out-of-order issue/execution architecture core to be included in a processor according to one or more embodiments of this disclosure. The solid lined boxes in FIGS. 11A-11B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 11A, a processor pipeline 1100 includes a fetch stage 1102, a length decode stage 1104, a decode stage 1106, an allocation stage 1108, a renaming stage 1110, a scheduling (also known as a dispatch or issue) stage 1112, a register read/memory read stage 1114, an execute stage 1116, a write back/memory write stage 1118, an exception handling stage 1122, and a commit stage 1124.

FIG. 11B shows processor core 1190 including a front end unit 1130 coupled to an execution engine unit 1150, and both are coupled to a memory unit 1170. Processor core 1190 and memory unit 1170 are examples of the types of hardware that can be used in connection with the implementations shown and described herein (e.g., processor 102, memory 120). The core 1190 may be a reduced instruction set computing (RISC) core, a complex instruction set computing (CISC) core, a very long instruction word (VLIW) core, or a hybrid or alternative core type. As yet another option, the core 1190 may be a special-purpose core, such as, for example, a network or communication core, compression engine, coprocessor core, general purpose computing graphics processing unit (GPGPU) core, graphics core, or the like. In addition, processor core 1190 and its components represent example architecture that could be used to implement logical processors and their respective components.

The front end unit 1130 includes a branch prediction unit 1132 coupled to an instruction cache unit 1134, which is coupled to an instruction translation lookaside buffer (TLB) unit 1136, which is coupled to an instruction fetch unit 1138, which is coupled to a decode unit 1140. The decode unit 1140 (or decoder) may decode instructions, and generate as an output one or more micro-operations, micro-code entry points, microinstructions, other instructions, or other control signals, which are decoded from, or which otherwise reflect, or are derived from, the original instructions. The decode unit 1140 may be implemented using various different mechanisms. Examples of suitable mechanisms include, but are not limited to, look-up tables, hardware implementations, programmable logic arrays (PLAs), microcode read only memories (ROMs), etc. In one embodiment, the core 1190 includes a microcode ROM or other medium that stores microcode for certain macroinstructions (e.g., in decode unit 1140 or otherwise within the front end unit 1130). The decode unit 1140 is coupled to a rename/allocator unit 1152 in the execution engine unit 1150.

The execution engine unit 1150 includes the rename/allocator unit 1152 coupled to a retirement unit 1154 and a set of one or more scheduler unit(s) 1156. The scheduler unit(s) 1156 represents any number of different schedulers, including reservations stations, central instruction window, etc. The scheduler unit(s) 1156 is coupled to the physical register file(s) unit(s) 1158. Each of the physical register file(s) units 1158 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 1158 comprises a vector registers unit, a write mask registers unit, and a scalar registers unit. These register units may provide architectural vector registers, vector mask registers, and general purpose registers (GPRs). In at least some embodiments described herein, register units 1158 are examples of the types of hardware that can be used in connection with the implementations shown and described herein (e.g., registers 110). The physical register file(s) unit(s) 1158 is overlapped by the retirement unit 1154 to illustrate various ways in which register renaming and out-of-order execution may be implemented (e.g., using a reorder buffer(s) and a retirement register file(s); using a future file(s), a history buffer(s), and a retirement register file(s); using register maps and a pool of registers; etc.). The retirement unit 1154 and the physical register file(s) unit(s) 1158 are coupled to the execution cluster(s) 1160. The execution cluster(s) 1160 includes a set of one or more execution units 1162 and a set of one or more memory access units 1164. The execution units 1162 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. Execution units 1162 may also include an address generation unit to calculate addresses used by the core to access main memory (e.g., memory unit 1170) and a page miss handler (PMH).

The scheduler unit(s) 1156, physical register file(s) unit(s) 1158, and execution cluster(s) 1160 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 1164). It should also be understood that where separate pipelines are used, one or more of these pipelines may be out-of-order issue/execution and the rest in-order.

The set of memory access units 1164 is coupled to the memory unit 1170, which includes a data TLB unit 1172 coupled to a data cache unit 1174 coupled to a level 2 (L2) cache unit 1176. In one exemplary embodiment, the memory access units 1164 may include a load unit, a store address unit, and a store data unit, each of which is coupled to the data TLB unit 1172 in the memory unit 1170. The instruction cache unit 1134 is further coupled to a level 2 (L2) cache unit 1176 in the memory unit 1170. The L2 cache unit 1176 is coupled to one or more other levels of cache and eventually to a main memory. In addition, a page miss handler may also be included in core 1190 to look up an address mapping in a page table if no match is found in the data TLB unit 1172.

By way of example, the exemplary register renaming, out-of-order issue/execution core architecture may implement the pipeline 1100 as follows: 1) the instruction fetch unit 1138 performs the fetch and length decoding stages 1102 and 1104; 2) the decode unit 1140 performs the decode stage 1106; 3) the rename/allocator unit 1152 performs the allocation stage 1108 and renaming stage 1110; 4) the scheduler unit(s) 1156 performs the scheduling stage 1112; 5) the physical register file(s) unit(s) 1158 and the memory unit 1170 perform the register read/memory read stage 1114; the execution cluster 1160 perform the execute stage 1116; 6) the memory unit 1170 and the physical register file(s) unit(s) 1158 perform the write back/memory write stage 1118; 7) various units may be involved in the exception handling stage 1122; and 8) the retirement unit 1154 and the physical register file(s) unit(s) 1158 perform the commit stage 1124.

The core 1190 may support one or more instructions sets (e.g., the x86 instruction set (with some extensions that have been added with newer versions); the MIPS instruction set of MIPS Technologies of Sunnyvale, CA; the ARM instruction set (with optional additional extensions such as NEON) of ARM Holdings of Sunnyvale, CA), including the instruction(s) described herein. In one embodiment, the core 1190 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology). Accordingly, in at least some embodiments, multi-threaded enclaves may be supported.

While register renaming is described in the context of out-of-order execution, it should be understood that register renaming may be used in an in-order architecture. While the illustrated embodiment of the processor also includes separate instruction and data cache units 1134/1174 and a shared L2 cache unit 1176, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

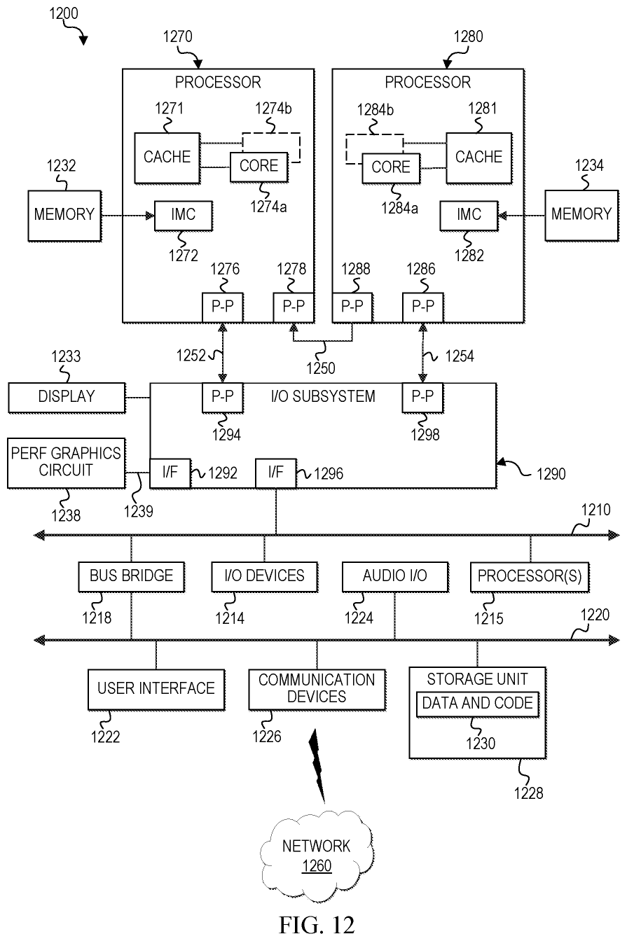

FIG. 12 illustrates a computing system 1200 that is arranged in a point-to-point (PtP) configuration according to an embodiment. In particular, FIG. 12 shows a system where processors, memory, and input/output devices are interconnected by a number of point-to-point interfaces. Generally, one or more of the computing systems or computing devices described herein may be configured in the same or similar manner as computing system 1200.

Processors 1270 and 1280 may be implemented as single core processors 1274a and 1284a or multi-core processors 1274a-1274b and 1284a-1284b. Processors 1270 and 1280 may each include a cache 1271 and 1281 used by their respective core or cores. A shared cache (not shown) may be included in either processors or outside of both processors, yet connected with the processors via P-P interconnect, such that either or both processors' local cache information may be stored in the shared cache if a processor is placed into a low power mode. It should be noted that one or more embodiments described herein could be implemented in a computing system, such as computing system 1200. Moreover, processors 1270 and 1280 are examples of the types of hardware that can be used in connection with the implementations shown and described herein (e.g., processor 102).

Processors 1270 and 1280 may also each include integrated memory controller logic (IMC) 1272 and 1282 to communicate with memory elements 1232 and 1234, which may be portions of main memory locally attached to the respective processors. In alternative embodiments, memory controller logic 1272 and 1282 may be discrete logic separate from processors 1270 and 1280. Memory elements 1232 and/or 1234 may store various data to be used by processors 1270 and 1280 in achieving operations and functionality outlined herein.

Processors 1270 and 1280 may be any type of processor, such as those discussed in connection with other figures. Processors 1270 and 1280 may exchange data via a point-to-point (PtP) interface 1250 using point-to-point interface circuits 1278 and 1288, respectively. Processors 1270 and 1280 may each exchange data with an input/output (I/O) subsystem 1290 via individual point-to-point interfaces 1252 and 1254 using point-to-point interface circuits 1276, 1286, 1294, and 1298. I/O subsystem 1290 may also exchange data with a high-performance graphics circuit 1238 via a high-performance graphics interface 1239, using an interface circuit 1292, which could be a PtP interface circuit. In one embodiment, the high-performance graphics circuit 1238 is a special-purpose processor, such as, for example, a high-throughput MIC processor, a network or communication processor, compression engine, graphics processor, GPGPU, embedded processor, or the like. I/O subsystem 1290 may also communicate with a display 1233 for displaying data that is viewable by a human user. In alternative embodiments, any or all of the PtP links illustrated in FIG. 12 could be implemented as a multi-drop bus rather than a PtP link.

I/O subsystem 1290 may be in communication with a bus 1210 via an interface circuit 1296. Bus 1210 may have one or more devices that communicate over it, such as a bus bridge 1218, I/O devices 1214, and one or more other processors 1215. Via a bus 1220, bus bridge 1218 may be in communication with other devices such as a user interface 1222 (such as a keyboard, mouse, touchscreen, or other input devices), communication devices 1226 (such as modems, network interface devices, or other types of communication devices that may communicate through a computer network 1260), audio I/O devices 1224, and/or a storage unit 1228. Storage unit 1228 may store data and code 1230, which may be executed by processors 1270 and/or 1280. In alternative embodiments, any portions of the bus architectures could be implemented with one or more PtP links.

Program code, such as code 1230, may be applied to input instructions to perform the functions described herein and generate output information. The output information may be applied to one or more output devices, in known fashion. For purposes of this application, a processing system may be part of computing system 1200 and includes any system that has a processor, such as, for example; a digital signal processor (DSP), a microcontroller, an application specific integrated circuit (ASIC), or a microprocessor.

The program code (e.g., 1230) may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

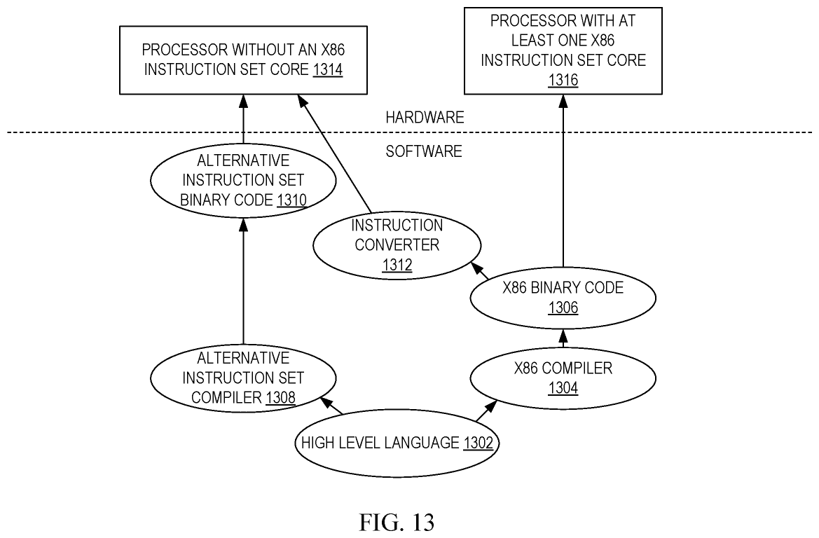

FIG. 13 is a block diagram contrasting the use of a software instruction converter to convert binary instructions in a source instruction set to binary instructions in a target instruction set according to embodiments of this disclosure. In the illustrated embodiment, the instruction converter is a software instruction converter, although alternatively the instruction converter may be implemented in software, firmware, hardware, or various combinations thereof. FIG. 13 shows a program in a high level language 1302 may be compiled using an x86 compiler 1304 to generate x86 binary code 1306 that may be natively executed by a processor with at least one x86 instruction set core 1316. The processor with at least one x86 instruction set core 1316 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1304 represents a compiler that is operable to generate x86 binary code 1306 (e.g., object code) that can, with or without additional linkage processing, be executed on the processor with at least one x86 instruction set core 1316. Similarly, FIG. 13 shows the program in the high level language 1302 may be compiled using an alternative instruction set compiler 1308 to generate alternative instruction set binary code 1310 that may be natively executed by a processor without at least one x86 instruction set core 1314 (e.g., a processor with cores that execute the MIPS instruction set of MIPS Technologies of Sunnyvale, CA and/or that execute the ARM instruction set of ARM Holdings of Sunnyvale, CA). The instruction converter 1312 is used to convert the x86 binary code 1306 into code that may be natively executed by the processor without an x86 instruction set core 1314. This converted code is not likely to be the same as the alternative instruction set binary code 1310 because an instruction converter capable of this is difficult to make; however, the converted code will accomplish the general operation and be made up of instructions from the alternative instruction set. Thus, the instruction converter 1312 represents software, firmware, hardware, or a combination thereof that, through emulation, simulation or any other process, allows a processor or other electronic device that does not have an x86 instruction set processor or core to execute the x86 binary code 1306.

One or more aspects of at least one embodiment may be implemented by representative instructions stored on a machine-readable medium which represents various logic within the processor, which when read by a machine causes the machine to fabricate logic to perform the one or more of the techniques described herein. Such representations, known as “IP cores” may be stored on a tangible, machine readable medium and supplied to various customers or manufacturing facilities to load into the fabrication machines that actually make the logic or processor. Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMS) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions. Accordingly, embodiments of the present disclosure also include non-transitory, tangible machine readable media containing instructions or containing design data, such as Hardware Description Language (HDL), which defines structures, circuits, apparatuses, processors and/or system features described herein. Such embodiments may also be referred to as program products.

The computing system depicted in FIG. 12 is a schematic illustration of an embodiment of a computing system that may be utilized to implement various embodiments discussed herein. It will be appreciated that various components of the system depicted in FIG. 12 may be combined in a system-on-a-chip (SoC) architecture or in any other suitable configuration capable of achieving the functionality and features of examples and implementations provided herein.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Other variations are within the scope of the following claims.

The architectures presented herein are provided by way of example only and are intended to be non-exclusive and non-limiting. Furthermore, the various parts disclosed are intended to be logical divisions only and need not necessarily represent physically separate hardware and/or software components. Certain computing systems may provide memory elements in a single physical memory device, and in other cases, memory elements may be functionally distributed across many physical devices. In the case of virtual machine managers or hypervisors, all or part of a function may be provided in the form of software or firmware running over a virtualization layer to provide the disclosed logical function.

Note that with the examples provided herein, interaction may be described in terms of a single computing system. However, this has been done for purposes of clarity and example only. In certain cases, it may be easier to describe one or more of the functionalities of a given set of flows by only referencing a single computing system. Moreover, the system for deep learning and malware detection is readily scalable and can be implemented across a large number of components (e.g., multiple computing systems), as well as more complicated/sophisticated arrangements and configurations. Accordingly, the examples provided should not limit the scope or inhibit the broad teachings of the computing system as potentially applied to a myriad of other architectures.

As used herein, unless expressly stated to the contrary, use of the phrase ‘at least one of’ refers to any combination of the named items, elements, conditions, or activities. For example, ‘at least one of X, Y, and Z’ is intended to mean any of the following: 1) at least one X, but not Y and not Z; 2) at least one Y, but not X and not Z; 3) at least one Z, but not X and not Y; 4) at least one X and at least one Y, but not Z; 5) at least one X and at least one Z, but not Y; 6) at least one Y and at least one Z, but not X; or 7) at least one X, at least one Y, and at least one Z.

Additionally, unless expressly stated to the contrary, the terms ‘first’, ‘second’, ‘third’, etc., are intended to distinguish the particular nouns (e.g., element, condition, module, activity, operation, claim element, etc.) they modify, but are not intended to indicate any type of order, rank, importance, temporal sequence, or hierarchy of the modified noun. For example, ‘first X’ and ‘second X’ are intended to designate two separate X elements that are not necessarily limited by any order, rank, importance, temporal sequence, or hierarchy of the two elements.

References in the specification to “one embodiment,” “an embodiment,” “some embodiments,”, “certain embodiments,” etc., indicate that the embodiment(s) described may include a particular feature, structure, or characteristic, but every embodiment may or may not necessarily include that particular feature, structure, or characteristic. Moreover, such phrases are not necessarily referring to the same embodiment.

While this specification contains many specific implementation details, these should not be construed as limitations on the scope of any embodiments or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, the separation of various system components and modules in the embodiments described above should not be understood as requiring such separation in all embodiments. It should be understood that the described program components, modules, and systems can generally be integrated together in a single software product or packaged into multiple software products.

Thus, particular embodiments of the subject matter have been described. Other embodiments are within the scope of this disclosure. Numerous other changes, substitutions, variations, alterations, and modifications may be ascertained to one skilled in the art and it is intended that the present disclosure encompass all such changes, substitutions, variations, alterations, and modifications as falling within the scope of the appended claims.

### EXAMPLES

Example 1 is at least one non-transitory machine-readable storage medium having instructions stored thereon, wherein the instructions, when executed on processing circuitry of a computing device, cause the processing circuitry to: detect, in computer program code, an indirect branch to call one of a plurality of functions using a first register; augment the computer program code to store an identifier of the indirect branch call in a second register; and augment the code for each function to: determine whether an identifier for the function matches the identifier stored in the second register; and render the first register unusable if the identifier for the function does not match the identifier stored in the second register.

Example 2 includes the subject matter of Example 1, wherein the instructions are to augment the code for each function to: use a conditional branch to cause program execution to halt if the identifier for the function does not match the identifier stored in the second register; and implement the code to render the first register unusable after the conditional branch and before the code for the function.

Example 3 includes the subject matter of Example 1 or 2, wherein the instructions are to augment the code for each function to determine whether the identifier for the function matches the identifier stored in the second register using an XOR operation of the identifier of the function and the second register value.

Example 4 includes the subject matter of any one of Examples 1-3, wherein the identifier is based on a type of the function.

Example 5 includes the subject matter of Example 4, wherein the identifier is a hash of the function type.

Example 6 includes the subject matter of any one of Examples 1-5, wherein the instructions are to augment the code for each function to render the first register unusable by setting the first register value to a predetermined constant if the identifier for the function does not match the identifier stored in the second register.

Example 7 includes the subject matter of any one of Examples 1-6, wherein the instructions are to augment the code for each function to render the first register unusable by implementing code to: set a third register value to 0 if the identifier for the function does not match the identifier stored in the second register; decrement the third register value; perform an OR operation on the first register value and the third register value; and store a result of the OR operation in the first register.

Example 8 includes the subject matter of any one of Examples 1-6, wherein the instructions are to augment the code for each function to render the first register unusable by implementing code to: set a third register value to 1 if the identifier for the function does not match the identifier stored in the second register; decrement the third register value; perform an AND operation on the first register value and the third register value; and store a result of the AND operation in the first register.

Example 9 includes the subject matter of any one of Examples 1-8, wherein the instructions are to augment the code for each function to include code to: determine whether the identifier for the function matches the identifier stored in the second register; and render the first register unusable if the identifier for the function does not match the identifier stored in the second register.

Example 10 includes the subject matter of any one of Examples 1-8, wherein the instructions are to augment the code for each function to call to one or more code segments that include code to: determine whether the identifier for the function matches the identifier stored in the second register; and render the first register unusable if the identifier for the function does not match the identifier stored in the second register.

Example 11 includes the subject matter of Example 10, wherein the instructions are to augment the code for each function to call a first code segment to determine whether the identifier for the function matches the identifier stored in the second register, the first code segment to call a second code segment to render the first register unusable if the identifier for the function does not match the identifier stored in the second register.

Example 12 is a method comprising: detecting, in computer program code, an indirect branch to call one of a plurality of functions using a first register; augmenting the computer program code to store an identifier of the indirect branch call in a second register; and augmenting the code for each function to: determine whether an identifier for the function matches the identifier stored in the second register; and render the first register unusable if the identifier for the function does not match the identifier stored in the second register.

Example 13 includes the subject matter of Example 12, wherein the code for each function is augmented to: use a conditional branch to cause program execution to halt if the identifier for the function does not match the identifier stored in the second register; and implement the code to render the first register unusable after the conditional branch and before the code for the function.

Example 14 includes the subject matter of Example 12 or 13, wherein the code for each function is augmented to determine whether the identifier for the function matches the identifier stored in the second register using an XOR operation of the identifier of the function and the second register value.

Example 15 includes the subject matter of any one of Examples 12-14, wherein the identifier is based on a type of the function.

Example 16 includes the subject matter of Example 15, wherein the identifier is a hash of the function type.

Example 17 includes the subject matter of any one of Examples 12-16, wherein the code for each function is augmented to render the first register unusable by setting the first register value to a predetermined constant if the identifier for the function does not match the identifier stored in the second register.

Example 18 includes the subject matter of any one of Examples 12-17, wherein the code for each function is augmented to render the first register unusable by implementing code to: set a third register value to 0 if the identifier for the function does not match the identifier stored in the second register; decrement the third register value; perform an OR operation on the first register value and the third register value; and store a result of the OR operation in the first register.

Example 19 includes the subject matter of any one of Examples 12-17, wherein the code for each function is augmented to render the first register unusable by implementing code to: set a third register value to 1 if the identifier for the function does not match the identifier stored in the second register; decrement the third register value; perform an AND operation on the first register value and the third register value; and store a result of the AND operation in the first register.

Example 20 includes the subject matter of any one of Examples 12-19, wherein the code for each function is augmented to include code to: determine whether the identifier for the function matches the identifier stored in the second register; and render the first register unusable if the identifier for the function does not match the identifier stored in the second register.

Example 21 includes the subject matter of any one of Examples 12-19, wherein the code for each function is augmented to call to one or more code segments that include code to: determine whether the identifier for the function matches the identifier stored in the second register; and render the first register unusable if the identifier for the function does not match the identifier stored in the second register.

Example 22 includes the subject matter of Example 21, wherein the code for each function is augmented to call a first code segment to determine whether the identifier for the function matches the identifier stored in the second register, the first code segment to call a second code segment to render the first register unusable if the identifier for the function does not match the identifier stored in the second register.

Example 23 includes the subject matter of any one of Examples 12-22, wherein the augmenting of the computer program code and the function code is performed by a compiler or a linker.

Example 24 is a system or apparatus comprising means to perform a method as in any preceding Example.

Example 25 is machine-readable storage including machine-readable instructions, when executed, to implement a method or realize an apparatus as in any preceding Example.

1. At least one non-transitory machine-readable storage medium having instructions stored thereon, wherein the instructions, when executed on processing circuitry of a computing device, cause the processing circuitry to:
detect, in computer program code, an indirect branch to call one of a plurality of functions using a first register;
augment the computer program code to store an identifier of the indirect branch call in a second register; and
augment the code for each function to:
determine whether an identifier for the function matches the identifier stored in the second register; and
render the first register unusable if the identifier for the function does not match the identifier stored in the second register.

2. The storage medium of claim 1, wherein the instructions are to augment the code for each function to:
use a conditional branch to cause program execution to halt if the identifier for the function does not match the identifier stored in the second register; and
implement the code to render the first register unusable after the conditional branch and before the code for the function.

3. The storage medium of claim 1, wherein the instructions are to augment the code for each function to determine whether the identifier for the function matches the identifier stored in the second register using an XOR operation of the identifier of the function and the second register value.

4. The storage medium of claim 1, wherein the identifier is based on a type of the function.

5. The storage medium of claim 4, wherein the identifier is a hash of the function type.

6. The storage medium of claim 1, wherein the instructions are to augment the code for each function to render the first register unusable by setting the first register value to a predetermined constant if the identifier for the function does not match the identifier stored in the second register.

7. The storage medium of claim 1, wherein the instructions are to augment the code for each function to render the first register unusable by implementing code to:
set a third register value to 0 if the identifier for the function does not match the identifier stored in the second register;
decrement the third register value;
perform an OR operation on the first register value and the third register value; and
store a result of the OR operation in the first register.

8. The storage medium of claim 1, wherein the instructions are to augment the code for each function to render the first register unusable by implementing code to:
set a third register value to 1 if the identifier for the function does not match the identifier stored in the second register;
decrement the third register value;
perform an AND operation on the first register value and the third register value; and
store a result of the AND operation in the first register.

9. The storage medium of claim 1, wherein the instructions are to augment the code for each function to include code to:
determine whether the identifier for the function matches the identifier stored in the second register; and
render the first register unusable if the identifier for the function does not match the identifier stored in the second register.

10. The storage medium of claim 1, wherein the instructions are to augment the code for each function to call to one or more code segments that include code to:
determine whether the identifier for the function matches the identifier stored in the second register; and
render the first register unusable if the identifier for the function does not match the identifier stored in the second register.

11. The storage medium of claim 10, wherein the instructions are to augment the code for each function to call a first code segment to determine whether the identifier for the function matches the identifier stored in the second register, the first code segment to call a second code segment to render the first register unusable if the identifier for the function does not match the identifier stored in the second register.

12. A method comprising:
detecting, in computer program code, an indirect branch to call one of a plurality of functions using a first register;
augmenting the computer program code to store an identifier of the indirect branch call in a second register; and
augmenting the code for each function to:
determine whether an identifier for the function matches the identifier stored in the second register; and
render the first register unusable if the identifier for the function does not match the identifier stored in the second register.

13. The method of claim 12, wherein the code for each function is augmented to:
use a conditional branch to cause program execution to halt if the identifier for the function does not match the identifier stored in the second register; and
implement the code to render the first register unusable after the conditional branch and before the code for the function.

14. The method of claim 12, wherein the code for each function is augmented to determine whether the identifier for the function matches the identifier stored in the second register using an XOR operation of the identifier of the function and the second register value.

15. The method of claim 12, wherein the identifier is based on a type of the function.

16. The method of claim 15, wherein the identifier is a hash of the function type.

17. The method of claim 12, wherein the code for each function is augmented to render the first register unusable by setting the first register value to a predetermined constant if the identifier for the function does not match the identifier stored in the second register.

18. The method of claim 12, wherein the code for each function is augmented to render the first register unusable by implementing code to:
set a third register value to 0 if the identifier for the function does not match the identifier stored in the second register;
decrement the third register value;
perform an OR operation on the first register value and the third register value; and
store a result of the OR operation in the first register.

19. The method of claim 12, wherein the code for each function is augmented to render the first register unusable by implementing code to:
set a third register value to 1 if the identifier for the function does not match the identifier stored in the second register;
decrement the third register value;
perform an AND operation on the first register value and the third register value; and
store a result of the AND operation in the first register.

20. The method of claim 12, wherein the code for each function is augmented to include code to:
determine whether the identifier for the function matches the identifier stored in the second register; and
render the first register unusable if the identifier for the function does not match the identifier stored in the second register.

21. The method of claim 12, wherein the code for each function is augmented to call to one or more code segments that include code to:
determine whether the identifier for the function matches the identifier stored in the second register; and
render the first register unusable if the identifier for the function does not match the identifier stored in the second register.

22. The method of claim 21, wherein the code for each function is augmented to call a first code segment to determine whether the identifier for the function matches the identifier stored in the second register, the first code segment to call a second code segment to render the first register unusable if the identifier for the function does not match the identifier stored in the second register.

23. The method of claim 12, wherein the augmenting of the computer program code and the function code is performed by a compiler or a linker.

24. A system comprising:
means to detect, in computer program code, an indirect branch to call one of a plurality of functions using a first register;
means to augment the computer program code to store an identifier of the indirect branch call in a second register; and
means to augment the code for each function to:
determine whether an identifier for the function matches the identifier stored in the second register; and
render the first register unusable if the identifier for the function does not match the identifier stored in the second register.

25. The system of claim 24, wherein the means to augment the code for each function to render the first register unusable are to augment the code to set the first register value to a predetermined constant if the identifier for the function does not match the identifier stored in the second register.
